(19) United States
(12) Patent Application Publication
(10) Pub. No.: US 2026/0049546 A1
(43) Pub. Date: Feb. 19, 2026

(54) SYSTEMS AND METHODS FOR PERFORMING LOCAL OPTIMIZATION OF ROCK PROPERTY ESTIMATION IN GEOLOGICAL FORMATIONS

(71) Applicant: Schlumberger Technology Corporation, Sugar Land, TX (US)

(72) Inventors: Paul Ryan Craddock, Scituate, MA (US); Jeffrey Miles, Arlington, MA (US); Lalitha Venkataramanan, Lexington, MA (US); Vikas Jain, Sugar Land, TX (US)

(21) Appl. No.: 19/297,403

(22) Filed: Aug. 12, 2025

Related U.S. Application Data
(60) Provisional application No. 63/682,621, filed on Aug. 13, 2024.

(51) Int. Cl. E21B 44/02; G06N 3/04; G06N 3/096

(52) U.S. Cl. CPC E21B 44/02; G06N 3/04; G06N 3/096; E21B 2200/22

(57) ABSTRACT

Systems and methods for performing local optimization of rock property estimation in geological formations are provided. A method includes: drilling into a rock formation using first drilling parameters, acquiring local data from a first sample from the drilling, acquiring test data from a second sample, selecting a local model input and output, receiving a pre-trained global model including a global model input and output, accessing the global model to extract global weights for global neuron layers, passing the global weights to a local model, training the local model with the local data using the passed global weights to generate local weight(s) corresponding to local neuron layer(s), feeding the test data into the trained local model to generate a prediction output, and based on the prediction: generating second drilling parameters to optimize drilling of the rock formation, and drilling into the rock formation using the second drilling parameters.

### CROSS-REFERENCE TO RELATED APPLICATION(S)

This application claims the benefit of and priority to U.S. Provisional Patent Application No. 63/682,621, filed on Aug. 13, 2024, the entire disclosure of which is incorporated herein by reference for all purposes.

### TECHNICAL FIELD

This disclosure generally relates to systems and methods for performing local optimization of rock property estimation in geological formations.

### BACKGROUND

When evaluating a geological rock formation for oil, natural gas, precious metals, critical minerals, carbon dioxide (CO₂) sequestration, hydrogen storage, geothermal potential, or other material content, it is beneficial to determine or estimate characteristics or properties of the formation. In many cases, the methods of making these evaluations and actions arising therefrom are by surface logging and wellbore logging measurements, and are encompassed by the disciplines of well-log analysis and petrophysics.

Petrophysical evaluations use a measurement of a bulk formation property or properties to interpret, usually via one or more mathematical models, the volumes and properties of solid rock and of fluid-filled pores in the formation, and to yield estimate(s) of certain desired properties of the formation. In oil and natural gas exploration, well-known formation properties of importance include total porosity, effective porosity, permeability, fluid saturation, and the like. In “critical minerals” exploration, formation properties of importance can include abundance of certain or diagnostic minerals that can contain economic concentrations of precious metals, such as lithium and nickel for battery manufacturing. In CO₂ sequestration, formation properties of importance can include absolute permeability relating to the containment potential of a reservoir sealing rock and porosity, absolute permeability, and relative permeability relating to the capacity and injectivity potential of the sequestration reservoir target.

Petrophysical evaluations nearly all rely on prior, quantitative knowledge of relevant fluid and rock properties to differentiate the solid-rock volume from the fluid-filled pore volume. A well-known example is the estimation of total porosity from a formation bulk density measurement, with knowledge of solid-rock grain density and fluid density of the formation, either standalone or in combination with other wellbore logging measurements. The majority of relevant solid-rock properties used in petrophysical evaluations cannot be measured directly using wellbore logging measurements but are instead inferred via calibrated (e.g., trained) models (e.g., physical model, empirical model, etc.). For example, a solid-rock grain density can be estimated via an empirical model from the mass concentrations of certain chemical elements in the solid rock, the latter obtained from nuclear spectroscopy wellbore logging measurements.

For cost and efficiency, conventionally, any petrophysical model can be used in any geological rock formation of interest (e.g., a “global” model). In practice, this is not often achievable, because geological rock formations are complex, heterogeneous, and do not have identical properties everywhere. For example, two polymorphic minerals, calcite and aragonite, have identical chemical composition (CaCO₃) but different grain densities (ρ_{calcite}˜2.71 g/cm³; ρ_{aragonite}˜2.95 g/cm³). These two minerals thus typically require different models to relate chemical elemental concentrations in a rock to the grain density and, by extension to the porosity, of that rock. The same is true for a significant number of other mineral components in common rock-types.

There is need and benefit, therefore, in regard to the potential accuracy of certain petrophysical evaluations to use geologically-specific, geographically-specific, regionally-specific, or formation-specific models (e.g., a “local” model). Unfortunately, training a local model (or more realistically, many local models) is generally time-consuming and may suffer from limited data, such that model usage may be highly restricted and prone to instability outside a narrow range of applications. Access to robust, data-driven models where there is limited data for training a model is a well-known and long-standing challenge in confident decision making for subsurface exploration, drilling, and production.

Accordingly, there is a need for systems and methods for performing local optimization of rock property estimation in geological formations.

### SUMMARY

This disclosure pertains to systems and methods for performing local optimization of rock property estimation in geological formations.

A first aspect of this disclosure pertains to a method, including: drilling into a rock formation to obtain a target material using first drilling parameters for drilling equipment, acquiring local data from measurement of a first sample from the drilling of the rock formation, the measurement of the first sample being a first measurement type, acquiring test data from measurement of a second sample from the rock formation, the measurement of the second sample being the first measurement type, selecting a local model input and a local model output for a local model corresponding to the first measurement type, receiving a pre-trained global model including a global model input and a global model output for the global model corresponding to the first measurement type, accessing the global model to extract a plurality of global weights respectively corresponding to a plurality of global neuron layers, passing the plurality of global weights respectively corresponding to the plurality of global neuron layers to a local model, training the local model with the local data using the passed plurality of global weights respectively corresponding to the plurality of global neuron layers to generate one or more local weights respectively corresponding to one or more local neuron layers, feeding the test data into the trained local model to generate a prediction of the local model output for the test data, and based on the prediction: generating second drilling parameters to optimize drilling of the rock formation for obtaining the target material, and drilling into the rock formation using the second drilling parameters for the drilling equipment to obtain the target material.

A second aspect of this disclosure pertains to the method of the first aspect, wherein the one or more local weights respectively corresponding to one or more local neuron layers are generated by adjusting one or more of the passed plurality of global weights while at least one of the passed plurality of global weights is unchanged.

A third aspect of this disclosure pertains to the method of the second aspect, wherein the unchanged at least one of the passed plurality of global weights is included in at least one unchanged global layer passed to the local model.

A fourth aspect of this disclosure pertains to the method of the first aspect, wherein the one or more local weights respectively corresponding to one or more local neuron layers are generated by generating at least one new local layer with new local weights while all of the passed plurality of global weights are unchanged.

A fifth aspect of this disclosure pertains to the method of the fourth aspect, wherein the unchanged passed plurality of global weights are included in unchanged global layers passed to the local model.

A sixth aspect of this disclosure pertains to a method, including: generating or obtaining data pertaining to one or more properties of one or more parts or samples of a geological formation based on at least one measurement of the one or more parts or samples of the geological formation, optimizing a model that accepts the data of the generating or obtaining data as an input and derives at least one petrophysical property of the geological formation, using a different set of data samples for the one or more properties of one or more parts or samples or the at least one measurement of the generating or obtaining data to refine the model from the optimizing the model, and deriving the at least one petrophysical property of the geological formation from the refined model.

A seventh aspect of this disclosure pertains to the method of the sixth aspect, wherein the one or more parts or samples of the geological formation includes one or more of: a rock chip, a rock core, a rock drill cutting, a rock outcrop, or a rock formation surrounding a borehole.

An eighth aspect of this disclosure pertains to the method of the sixth aspect, wherein the at least one measurement is performed on one or more of: the one or more parts or samples of the geological formation conveyed to a surface of the geological formation, or the one or more parts or samples located within a borehole penetrating the geological formation.

A ninth aspect of this disclosure pertains to the method of the sixth aspect, wherein the at least one measurement includes one or more of: a gamma ray measurement, a neutron-induced gamma ray spectroscopy measurement, a gamma ray-induced gamma ray spectroscopy measurement, an acoustic log measurement, a nuclear magnetic resonance measurement, bulk density, thermal neutron porosity, epithermal neutron porosity, a pulsed-neutron measurement, a resistivity measurement, a conductivity measurement, an elemental concentration, a sonic property, an ultrasonic property, a dielectric property, a borehole image, seismic data, a fiber optic measurement, a gravity measurement, or a combination thereof.

A tenth aspect of this disclosure pertains to the method of the sixth aspect, wherein the at least one petrophysical property includes one or more of: rock grain density, rock apparent thermal neutron porosity, rock apparent epithermal neutron porosity, rock total porosity, rock effective porosity, rock hydrogen index, rock permittivity, rock thermal-neutron absorption cross-section, matrix fast-neutron elastic cross-section, rock photoelectric factor, rock permeability, cation-exchange capacity of the rock, a rock mineral concentration, a rock atomic elemental concentration, rock heat capacity, rock enthalpy, rock thermal conductivity, a rock reactivity rate with respect to an acid, a rock reactivity rate with respect to carbon dioxide, a rock propensity to produce geological hydrogen, elastic moduli, a mechanical property, or a combination thereof.

An eleventh aspect of this disclosure pertains to the method of the sixth aspect, wherein the model includes one or more neural networks.

A twelfth aspect of this disclosure pertains to the method of the eleventh aspect, wherein at least one of the one or more neural networks includes at least one of: an artificial neural network (ANN), a Bayesian neural network (BNN), a convolution neural network, or a combination thereof.

A thirteenth aspect of this disclosure pertains to the method of the sixth aspect, wherein: the model is trained on a set of data from a global variety of geological formations, and the different set of data samples used to refine the model is based on a local subset of geological formations.

A fourteenth aspect of this disclosure pertains to the method of the sixth aspect, wherein: the model is trained on a global dataset of samples, and the different set of data samples used to refine the model includes a smaller number of samples than the global dataset.

A fifteenth aspect of this disclosure pertains to the method of the sixth aspect, wherein the refining the model based on the different set of data samples is based on at least one confidence assessment process applied to the model in a context of new data.

A sixteenth aspect of this disclosure pertains to the method of the sixth aspect, wherein: the model includes a plurality of model coefficients, and the refining the model includes updating a subset of the coefficients whose values were learned in training the model.

A seventeenth aspect of this disclosure pertains to the method of the sixth aspect, wherein: the model includes a plurality of model coefficients, and the refining the model includes incorporating a new set of coefficients into the model whose values are learned during the refining the model.

An eighteenth aspect of this disclosure pertains to a system, including: one or more processors, memory accessible to the one or more processors, and processor-executable instructions stored in the memory and executable by the one or more processors to instruct the system to: drill into a rock formation to obtain a target material using first drilling parameters for drilling equipment, acquire local data from measurement of a first sample from the drilling of the rock formation, the measurement of the first sample being a first measurement type, acquire test data from measurement of a second sample from the rock formation, the measurement of the second sample being the first measurement type, select a local model input and a local model output for a local model corresponding to the first measurement type, receive a pre-trained global model including a global model input and a global model output for the global model corresponding to the first measurement type, access the global model to extract a plurality of global weights respectively corresponding to a plurality of global neuron layers, pass the plurality of global weights respectively corresponding to the plurality of global neuron layers to a local model, train the local model with the local data using the passed plurality of global weights respectively corresponding to the plurality of global neuron layers to generate one or more local weights respectively corresponding to one or more local neuron layers, feed the test data into the trained local model to generate a prediction of the local model output for the test data, and based on the prediction: generate second drilling parameters to optimize drilling of the rock formation for obtaining the target material, and drill into the rock formation using the second drilling parameters for the drilling equipment to obtain the target material.

A nineteenth aspect of this disclosure pertains to the system of the eighteenth aspect, wherein the one or more local weights respectively corresponding to one or more local neuron layers are generated by adjusting one or more of the passed plurality of global weights while at least one of the passed plurality of global weights is unchanged.

A twentieth aspect of this disclosure pertains to the system of the nineteenth aspect, wherein the unchanged at least one of the passed plurality of global weights is included in at least one unchanged global layer passed to the local model.

A twenty-first aspect of this disclosure pertains to the system of the eighteenth aspect, wherein the one or more local weights respectively corresponding to one or more local neuron layers are generated by generating at least one new local layer with new local weights while all of the passed plurality of global weights are unchanged.

A twenty-second aspect of this disclosure pertains to the system of the twenty-first aspect, wherein the unchanged passed plurality of global weights are included in unchanged global layers passed to the local model.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF DRAWINGS

To describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings.

FIG. 1 is a schematic view of an example of a geologic environment.

FIG. 2 is a schematic diagram of an example workflow.

FIG. 3 is a schematic diagram of an example artificial neural network (ANN) model.

FIG. 4 is a is a schematic diagram of another example artificial neural network (ANN) model.

FIG. 5 is a schematic diagram of an example workflow for a support vector machine (SVM) classification.

FIG. 6 is a graph of experimental results using an example embodiment of the present disclosure.

FIG. 7 is a flowchart for an example workflow.

FIG. 8 is a flowchart for an example method.

FIG. 9 is a flowchart for an example method.

FIG. 10 illustrates certain components that may be included within a computer system according to an example embodiment of the present disclosure.

Before explaining the disclosed embodiment of this disclosure in detail, it is to be understood that the invention is not limited in its application to the details of the particular arrangement shown, as the invention is capable of other embodiments. Example embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While the subject disclosure applies to embodiments in many different forms, specific embodiments are shown in the drawings and will be described in detail herein with the understanding that the present disclosure is an example of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention. In the description of the drawings, like reference numerals refer to like elements.

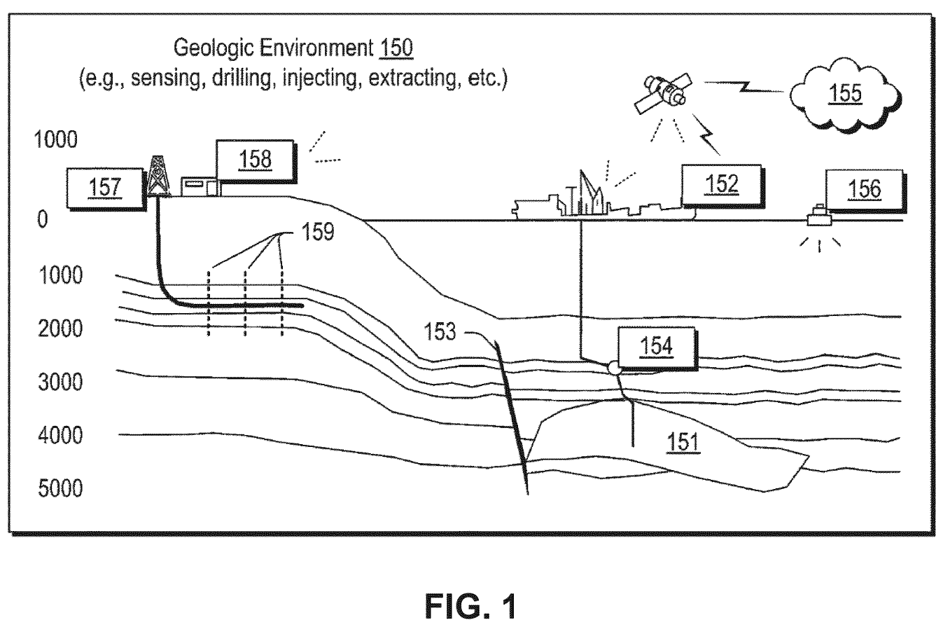

FIG. 1 is a schematic view illustrating an example of a geologic environment.

In the example of FIG. 1, an example geologic environment 150 may include layers (e.g., stratification) that may include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the one or more networks 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled at a wellsite for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

Example embodiments may utilize generalizable data-driven frameworks for delivering fine-tuned or locally optimized petrophysical models. To provide beneficial purpose, example embodiments may enable optimization of models that honor regional or local differences among complex geological rock formations (e.g., to be locally useful across diverse reservoirs and geographies), while also reducing the burden for analysts or systems to intervene during the process of model training and deployment (e.g., to reduce subjectivity, cost, and time of service delivery). Collectively, the one or more methods employ the concept of “transfer learning” built on top of one or more data-driven frameworks.

In describing example embodiments, this disclosure illustrates one or more methods with specific example or examples, but the scope of the methods is not limited to those examples, use-cases, or beneficial applications thereof, explicitly described herein.

Example embodiments may be based on a data-driven framework known as an artificial neural network (ANN). The principles and functions of ANN are well-known to those skilled in the art. In brief, ANNs are computational models with an architecture inspired by neural connections in the human brain, which allow for data (e.g., information) flow from input(s) to output(s) via a plurality of neurons organized in one or more layers. An ANN model is one in which the neuron weights (e.g., akin to neural connection strengths) have been trained to recognize patterns (e.g., correlations) among the input data and make predictions about an output datum or data based on properties of the input data. An example of an ANN used in well-log and petrophysics modeling is given in International Patent Application No. PCT/US2023/010163, filed on Jan. 5, 2023, to Craddock et al., with the title “Rock property measurements based on spectroscopy data”; hereafter “Craddock1.” In Craddock1, a set of well-log-measurable rock chemical elements (e.g., input data) is used to estimate (e.g., predict) useful rock petrophysical properties (e.g., output data) such as rock matrix density or matrix Sigma. A limitation of a data-driven model, generally, is that its weights are conditioned only on data available during a one-time model training and are thereafter fixed. The input(s) and output(s) of the training data for any particular model define a multi-dimensional space within which the model has been optimized. In practice, this fixed model is expected to perform accurately on new data only if it lies close to the multi-dimensional range of data used for training the model. In reference to the aforementioned example, we recognize that the correlations between certain measurable rock chemical elements (e.g., Si, Al, Fe, etc.) and a desired output petrophysical property (e.g., matrix mineralogy, matrix Sigma) is not the same for every geological rock formation. Therefore, any single, fixed model for the aforementioned use-case will not perform accurately in every geological formation. Unfortunately, it is impractical, in respect of both availability of data and computational time, to calibrate or train a model for every geological formation from scratch. The concept of transfer learning applied to ANN modeling of geological rock properties here becomes useful.

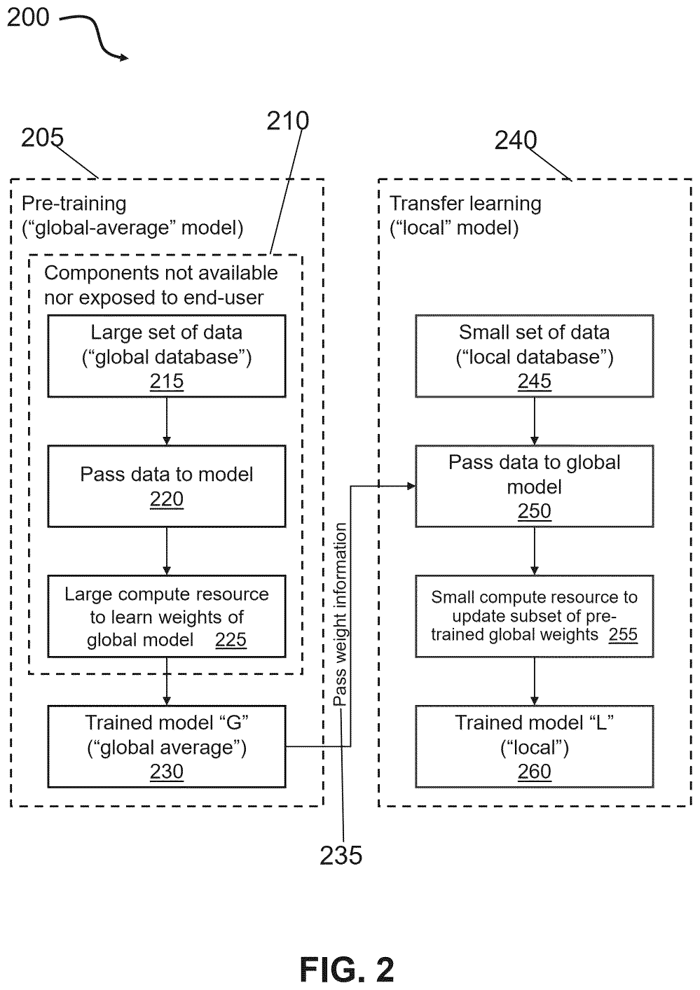

FIG. 2 is a schematic diagram of an example workflow.

An example workflow 200 of a method of transfer learning is described by way of general example with reference to FIG. 2. In example embodiments, transfer learning may be used to exploit the knowledge learned from one ANN model (e.g., the information conveyed by the trained neuron coefficients or weights of a model) applied to a specific petrophysical analysis and repurpose it for the same petrophysical analysis under related but different settings, such as the same petrophysical analysis used in a different geological rock formation. In example embodiments, the information contained within every neuron in the ANN may be described by the terms weight(s) or weight value(s). Any reference to a weight may encompass any or all of the neuron information comprising weight, summation function, bias, and activation function, which are known components of neurons in ANN models. Any reference to a weight is not intended to be limited to only the neuron weight in a strict sense. In the FIG. 2 example workflow 200, an ANN model is trained from scratch (e.g., pre-training 205). This first training includes components that should not be available nor exposed to end-user 210, which may include both a large set of training data 215 (e.g., 10⁴ to 10⁶ samples for some models) and large computing resources 225 (e.g., hours to days to week of training time for some models) to which the large set of training data 215 is passed at 220. This training data should contain a set of samples that is both large in number and diverse with respect to the property space (e.g., data values) of the petrophysical features (e.g., input data) and petrophysical target (e.g., desired output data). Thus, this first set of training data may be considered an approximate global representation of the relevant petrophysical properties of geological rock formations and the correlations within the petrophysical data to be learned during training. Hence, the first trained model is here termed a “global” model 230, which can be labeled as model “G”. It should be noted that a typical analyst of a petrophysical model rarely, if ever, has access to an adequate database required to independently train such a globally representative model from scratch. In practice, the pre-training 205 is done once as a pre-conditioning step and not by the typical analysts. The information contained in the pre-trained model G 230 (e.g., the learned weights of the global model) would already exist (e.g., passed from the trained model G 230 to a local model at 235) by the time an analyst would be accessing the data, and the information is made available to the analyst and systems without any need for the analyst to again pre-train the model G. The part of the example workflow 200 performed by an analyst or system in example embodiments is here referred to as “transfer learning.” Transfer learning 240 may utilize a significantly smaller set of training data 245 (e.g., 10² to 10³ samples for some models) and less computer resources 255 (e.g., minutes of training time) compared to pre-training. This is possible because transfer learning adopts the weights of an existing model G (e.g., at 235) and updates only a subset of those weights during training of a locally optimized model 260 (here termed “local” model, or simply model “L” with reference to FIG. 2). Given that the number of neurons with information to be optimized in training model L is smaller, the amount of data and compute time required is also smaller.

This transfer learning approach is logical in the geological context. For example, the local dataset is typically smaller and less diverse than what would be required to train a satisfactory local model from scratch (e.g., without any trained neuron weights). By applying transfer learning (e.g., by starting from an existing set of pre-trained weights), the local model may be optimized for the available local data, but can continue to retain the broader geological information from a pre-trained global model (e.g., at 250). Additionally, the petrophysical correlations in the pre-trained global model are often at least approximately valid for the local rock formation, even if they require fine-tuning. Therefore, the pre-trained global model is often a good starting point for an efficient optimization of a local model, even for the geological rock types and their properties in the local dataset that are not exactly represented in the original global dataset.

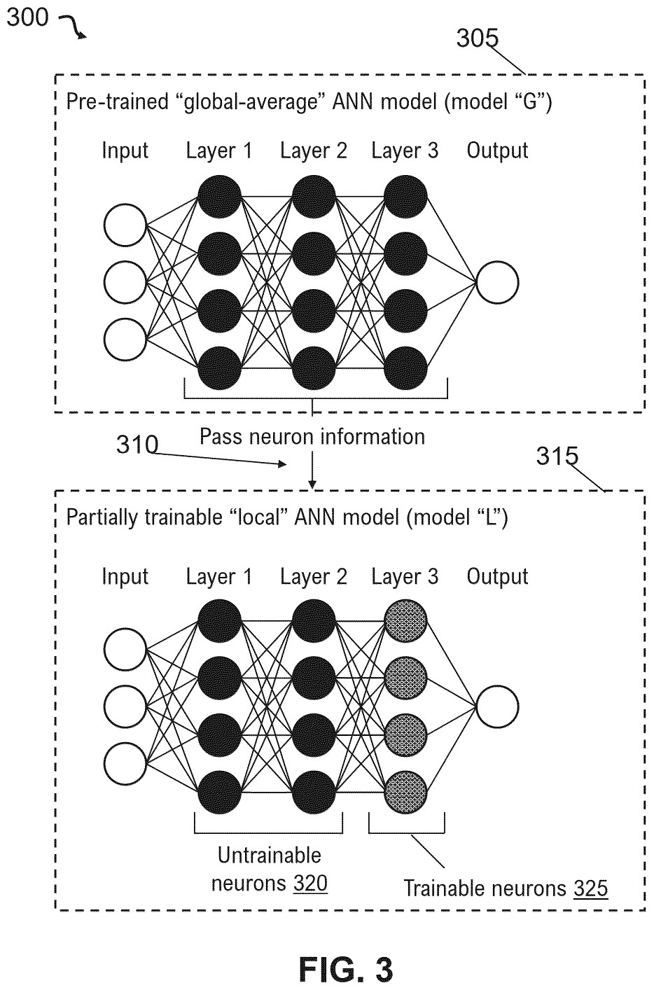

FIG. 3 is a schematic diagram of an example artificial neural network (ANN) model.

In an example embodiment, local model optimization may include replacing or updating a subset of model weights that exist in the fixed architecture of the pre-trained global-average ANN model. This is illustrated with reference to FIG. 3. FIG. 3 represents an architecture of an example ANN model 300. It should be noted that that the number of data inputs, ANN layers, ANN neurons, and data outputs shown in the FIG. 3 example is purely illustrative, and embodiments are not limited to those shown. The data input to (e.g., one or more petrophysical properties, like measurable rock chemical elements) and data output from (e.g., one or more petrophysical properties, like matrix density or matrix Sigma) the ANN are illustrated as white-filled circles. The neurons with their associated information (e.g., components from the set of neuron weights, summation, bias, and activation function) in the ANN are illustrated as black-filled circles. All the neuron information from a pre-trained global ANN model 305 are passed at 310 to a partially-trainable local model 315. A subset of neuron information that cannot be updated (e.g., untrainable neurons 320) are illustrated as black-filled circles (e.g., Layers 1 and 2 of the FIG. 3 example local model 315). A subset of neuron information that can be updated (e.g., trainable neurons 325) are illustrated as dot-filled circles (e.g., Layer 3 of the FIG. 3 example local model 315). The end-user may provide a set of new training data (e.g., model input and target output) that may allow the subset of neuron information values (e.g., trainable neurons 325) to be modified from the original weights of the same layer of the global model 305. The set of new training data provided by the end-user may be different from the set of original global training data, which is generally not available to the end-user, that was used to pre-train the global-model. Hence, the values of the weights in the trainable neurons 325 (e.g., layer 3 of the local model 315) will be different in the local model than in the global model (e.g., layer 3 of the global model 305), with the benefit of providing a more accurate estimate of a local output petrophysical property given a set of local input petrophysical properties. This may be referred to as “fine-tuning” of the weights of a subset of neurons. It should be noted that not all neuron weights learned by the pre-trained global model will be trainable, and some set of neuron weights are thus the same in the local model as in the global model. In some example embodiments, lower layers (e.g., layers 1 and 2 of the local model 315) may be untrainable because these layers may convey general (or global) knowledge (e.g., independent of any specific geological formation), whereas higher layers (e.g., layer 3 of the local model 315) may convey specific (or local) knowledge and may be allowed to be updated for a specific task.

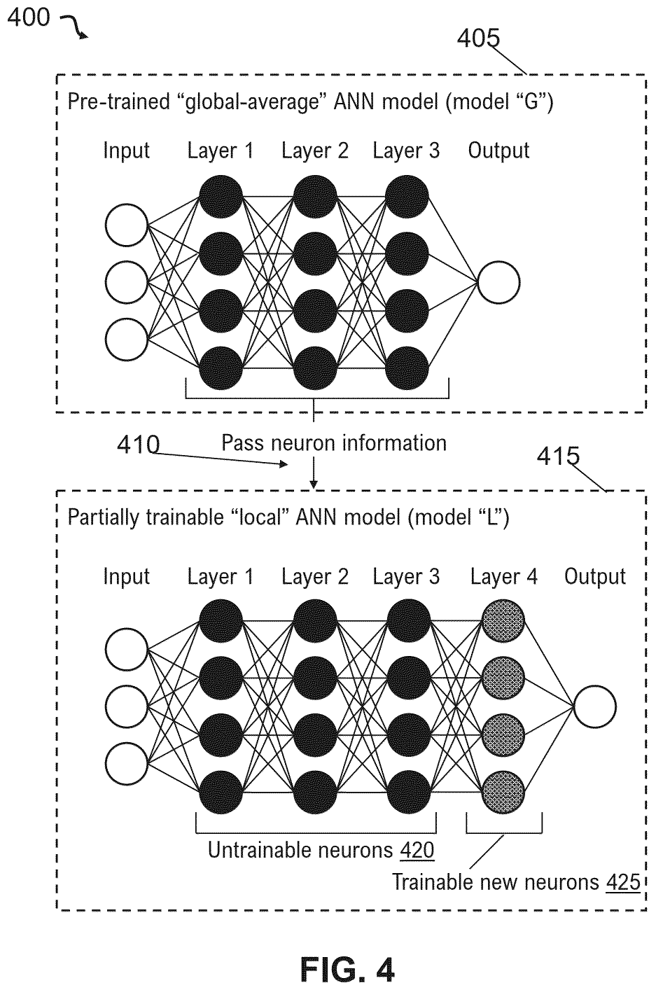

FIG. 4 is a is a schematic diagram of another example artificial neural network (ANN) model.

In another example embodiment, local model optimization may include adding an entirely new set of model neurons and their associated information (e.g., weights, bias, etc.) that did not exist in the architecture of the pre-trained global-average ANN model. This is illustrated with reference to FIG. 4. It should be noted that that the number of data inputs, ANN layers, ANN neurons, and data outputs shown in the FIG. 4 example is purely illustrative, and embodiments are not limited to those shown. In FIG. 4, in an example ANN model 400, all weights from a pre-trained global ANN model 405 are passed to (at 410) and preserved in a local ANN model 415. The neurons with the original weights that are not trainable in the local model 415 (e.g., untrainable neurons 420) are illustrated as black-filled circles (e.g., Layers 1-3 of the FIG. 4 example local model 315). New local knowledge is captured by the addition of trainable new neurons 425 whose weights are conditional only on the much smaller set of local training data. The new trainable neurons 425 are illustrated as dot-filled circles (e.g., Layer 4 of the FIG. 4 example local model 415). The new neurons 425 are shown as a new layer (“Layer 4”) connected directly to the ANN model output, because, in some examples, a higher layer may generally convey task-specific information. However, example embodiments are not limited to this process of adding neurons to the ANN. For example, an intermediate layer also could be added, or a new layer could be added immediately following the input layer. While FIG. 4 shows an example in which the new Layer 4 of the local model 415 has the same number of neurons as preceding layers, embodiments are not limited thereto, and the number of neurons in any newly added layer(s) does not have to be the same as in preceding layers in all embodiments.

In some embodiments, the decision to train a local model may be based on comparisons among the available local data and the multi-dimensional space of data that were used to train the global model. One approach is to apply methods for confidence assessment, for example as described in U.S. patent application Ser. No. 18/352,873, filed on Jul. 14, 2023, to Miles et al. with the title “Methods for Confidence Assessment with Feature Importance in Data-Driven Algorithms.” In this approach, new data (e.g., data distribution) derived from measurements of local samples are compared to the data space in which the global model was optimized, and a confidence score is computed based on the distance of the local dataset to the global dataset. The relative importance of the various input features can also be incorporated via this approach. Other simpler methods of outlier detection may also be applied for new local data samples with respect to the global pre-training data. In some instances, the Euclidean distance (or L2 norm) of the local data input features and/or target properties can be computed with respect to the global pre-training data, and a confidence score or decision about training a local model can be derived from the results of the global model pre-training.

Another example embodiment of the present disclosure may be based on a data-driven framework known as a Bayesian neural network (BNN). A BNN generally includes the similar architectural components as in an ANN as described above, e.g., model input, model neurons with associated weights, and model output. One difference between a BNN and an ANN is that the values of these inputs, neuron weights, and outputs are given as distributions with certain probabilities in the BNN, as opposed to discrete values in the ANN. Given that BNNs encode, not only to make predictions of an output property value, but also the probability distribution associated with the output property value, the training of a BNN can be especially dependent upon access to a large and diverse set of data and large computing resources. For example, a BNN model may be trained only one time on a large set of data, and then would be fixed thereafter. Thus, the example embodiments described above and with reference to FIGS. 2-4 for transfer learning as applied to an ANN may similarly and beneficially apply to a BNN, and for convenience will not be described again.

Another example embodiment of the present disclosure may be based on a data-driven framework known as an autoencoder. In some example embodiments, an autoencoder may be an architecture including two ANNs, the first ANN may be used to encode (e.g., transform) the input data to a different data representation and the second ANN may be used to decode the transformed data representation back to as close as possible a representation of the original input data. Autoencoders have found common use in such tasks as denoising of data and classification of noisy data because the encoded or transformed data representation may learn key features and may ignore noise. An example of a variational autoencoder used in well-log and petrophysics modeling is given in International Patent Application No. PCT/US2020/021774, filed on Mar. 9, 2020, to Craddock et al., with the title “Estimation of mineralogy and reconstructing elements of reservoir rock from spectroscopy data”; hereafter “Craddock2” and Craddock P. R. et al., “Enhanced mineral quantification and uncertainty analysis from downhole spectroscopy logs using variational autoencoders,” Petrophysics, vol. 62, pp. 614-629 (2021); hereafter “Craddock3.” In Craddock2 and Craddock 3, a set of well-log-measurable rock chemical elements (input data) was used to estimate (predict) the mineral concentrations of the rock (output data) as well as reconstruct the original element input data. Thus, the example embodiments described above and with reference to FIGS. 2-4 for transfer learning as applied to an ANN may similarly and beneficially apply to autoencoders including two ANNs, and for convenience will not be described again, and for convenience will not be described again.

The above embodiments have generally described transfer learning as applied to neural network models. These machine-learning methods are useful for regression analysis and beneficial for the estimation of geological rock properties that have continuous distributions, such as continuously varying mineralogy, matrix density, or porosity, and the like. The concept of transfer learning can, however, be similarly extended to machine-learning methods that are used for classification analysis of discrete properties, such as could be used for the classification of geological rock lithofacies, or for delineating geological zones, facies, horizons, strata, etc., according to an actionable metric or criterion. One common machine-learning method for classification applications includes a support vector machine (SVM). Thus, in another example embodiment, transfer learning may be based on a data-driven framework known as an SVM. Other methods of data classification, such as random forests, similarly fall within the scope of example embodiments. An SVM maps data points in high-dimensional space and attempts to discretize the data points among an optimal number of classes by finding hyperplane(s) in the high-dimensional space with the largest distance, or margin, between classes. The dimensionality of the model may correspond to the number of data feature types.

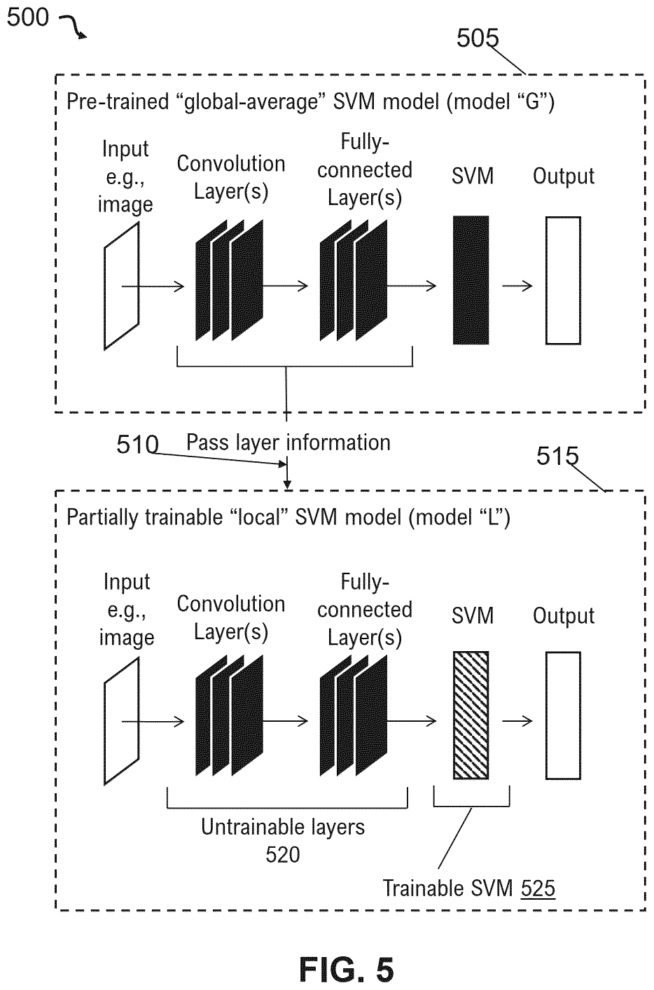

FIG. 5 is a schematic diagram of an example workflow for a support vector machine (SVM) classification.

Transfer learning for SVM classification is illustrated with reference to FIG. 5. FIG. 5 represents an architecture of a convolutional neural network with convolutional and fully connected layers and a SVM classifier. It should be noted that the number of data inputs, convolutional and fully connected layers and their optional hyperparameters (e.g., dropout layers, nonlinear activation layer), and other possible architectural components shown in the FIG. 5 example is purely illustrative, and embodiments are not limited to those shown. The data input could be, for example, a grayscale, red/green/blue (RGB), or other colormap image, for example, derived from borehole measurements, e.g., using formation imaging sondes. The output could be, for example, a lithofacies classification based on the image properties of the input data. In FIG. 5, in an example workflow 500, an example process for optimizing a pre-trained global SVM model 505 for a local (e.g. specific) task is, as shown in FIG. 5, by passing (at 510) a convolutional layer (or layers) and a fully connected layer (or layers) to a local SVM model 415 that is accessible by an end-user, and allowing an SVM classifier (e.g., a trainable SVM 525) to be updated based on the provision of a local training set of data. In FIG. 5, the input and output are illustrated as unshaded layers; the global model pre-trained layers (e.g., convolutional, fully-connected, and SVM layers of the global model 505) are illustrated as black layers; untrainable local layers 520 (e.g., convolutional and fully-connected layers of the local model 515) are illustrated as black layers; and the trainable SVM 525 is illustrated as a hatched layer. Other processes for achieving the same desired outcome are implicit in example embodiments, such as inclusion and optimization of other architectural components, e.g., Softmax, maximum pooling, global average pooling, nonlinear activation functions, and the like.

In general, the examples of transfer learning described above may be applied to any data-driven model architectures for application to geological rock property interpretation. The common aspects of the workflow include the use of a global model that, in practice, has been pre-trained once using a large global dataset, followed by use of a local dataset that is routinely smaller and less diverse than the global dataset to refine a subset of the global model parameter values. Following the example embodiments above, additional parameters may also be added for optimization with the local dataset.

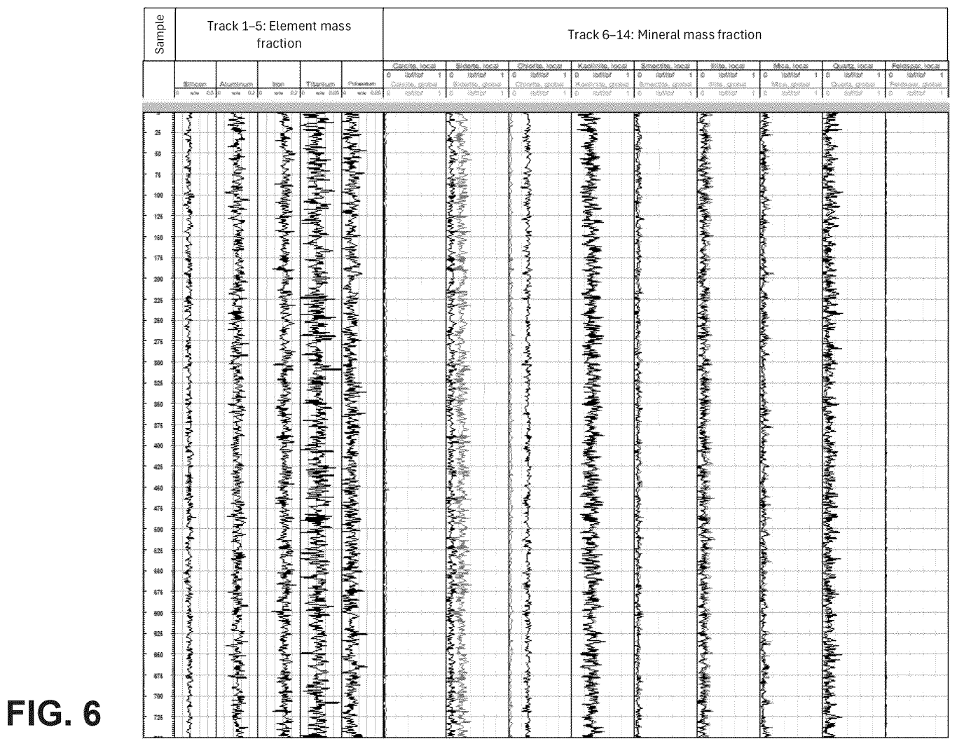

FIG. 6 is a graph of experimental results using an example embodiment of the present disclosure.

One beneficial example of transfer learning applied to borehole petrophysical log analysis is illustrated by FIG. 6. The described example pertains to optimizing the quantification of rock mineral concentrations from rock elemental concentrations derived from borehole nuclear spectroscopy logging measurements. The illustrative geological example is an iron (Fe)- and titanium (Ti)-rich shale as provided in and used by Kumar, S. et al., “Mineralogical and morphological characterization of Older Cambay Shale from North Cambay Basin, India: Implication for shale oil/gas development,” Marine and Petroleum Geology, vol. 97, pp. 339-354 (2018), https://doi.org/10.1016/j.marpetgeo.2018.07.020, which was characterized by the presence of abundant Fe-rich clays like chamosite, the Fe-endmember of chlorite; and Choudhury et al., “Authigenic Fe mineralization in shallow to marginal marine environments: A case study from the Late Paleocene—Early Eocene Cambay Shale Formation,” Minerals, vol. 13, p. 646 (2023), https://doi.org/10.3390/mini3050646. The geochemical (elemental) characteristics of the shale are illustrated by the top-to-bottom continuous curves in Tracks 1-5 of FIG. 6 (plotting the dry-weight mass fractions of silicon (Si), aluminum (Al), Fe, Ti, and potassium (K), respectively). Note that equivalent curves are not shown for all common elements in geological rock formations (e.g., calcium (Ca), magnesium (Mg), sodium (Na), sulfur (S)). Interpreted select mineral concentrations of the shale are illustrated by the continuous curves in Tracks 6-14 of FIG. 6 (plotting the mass fractions of calcite, siderite, chlorite, kaolinite, smectite, illite, muscovite [mica], quartz, and feldspar, respectively). Note that equivalent curves are not shown for all interpreted trace minerals in this example. One set of curves in Tracks 6-14 of FIG. 6 (shown as gray curves) plot estimated mineral concentrations output from a global-average mineralogical model as described in Craddock3. The previously-trained global mineralogical model erroneously estimates 20-30 wt % of the Fe-rich carbonate siderite, which is otherwise known to be absent or present at generally trace-to-minor abundance. Likewise, the global mineralogical model erroneously estimates only 1-5 wt % of chlorite, which is otherwise known to be present as predominantly chamosite at concentrations up to 30 wt %. The poor accuracy of this global model inherently reflects the absence and representation of Fe-rich chlorites in the original training dataset. Indeed, this reflects the fact that sedimentary chlorites tend to be more magnesian on average than the chamosite endmember, as described in Li. C, et al., “Mineral chemistry of chlorite in different geologic environments and its implications for porphyry Cu±Au±Mo deposits,” Ore Geology Reviews, vol. 149, p. 105112, 2022; hereafter, “Li”. In Li, the global model erroneously distributed the high Fe content of the rock into siderite (Fe-carbonate) instead of into chamosite (Fe-chlorite).

With local knowledge of the mineralogical and geochemical associations of the Fe- and Ti-rich shale derived from laboratory rock measurements, a local mineralogical model was trained in accordance with an example embodiment, via the method of transfer learning, using the model weights of the global mineralogical model as a basis for optimizing the local model. The output from the local mineralogical model used on the same set of elemental dry-weight mass fractions is also shown in Tracks 6-14 of FIG. 6 (shown as black dashed curves). Some beneficial observations are warranted. First, the local model predicts high concentration of chlorite consistent with local expectation. Second, the local model eliminates high abundance of siderite, recognizing that the local model has learned to associate high Fe contents in this formation with Fe-chlorite and not Fe-carbonate. Third, the concentrations of other minerals, such as quartz, feldspar, and illite, are nearly unchanged between the local and global model outputs. This is because the method of transfer learning has preserved previously learned global knowledge within the locally optimized model. This beneficial transfer of global knowledge would not be possible if a local model were trained from scratch using only a limited and locally representative dataset.

The above illustrated methods and examples of transfer learning apply to a large number of petrophysical interpretation models and petrophysical properties. For example, instead of only elemental concentrations, the inputs to the model in other use-cases could be selected from a group of borehole measurements and their measured properties including but not limited to: bulk density, thermal neutron porosity, epithermal neutron porosity, resistivity, gamma ray, acoustic, nuclear magnetic resonance, neutron-induced gamma ray spectroscopy, gamma ray-induced gamma ray spectroscopy, and dielectric measurements, and combinations thereof. In addition, the outputs from the model in other use-cases could be selected from a group of formation properties including but not limited to: rock grain density, rock apparent thermal neutron porosity, rock apparent epithermal neutron porosity, rock total porosity, rock effective porosity, rock hydrogen index, rock permittivity, rock thermal-neutron absorption cross section, matrix fast-neutron elastic cross section, rock photoelectric factor, rock permeability, cation-exchange capacity of the rock, rock mineral concentrations (e.g., silicates, carbonates, sulfates, sulfides, etc.) or rock lithology (e.g., shale volume), rock atomic elemental concentrations (such as lithium), rock heat capacity, rock enthalpy, rock thermal conductivity, rock reactivity rates with respect to an acid, rock reactivity rates with respect to CO₂, elastic moduli or other mechanical properties, and combinations thereof.

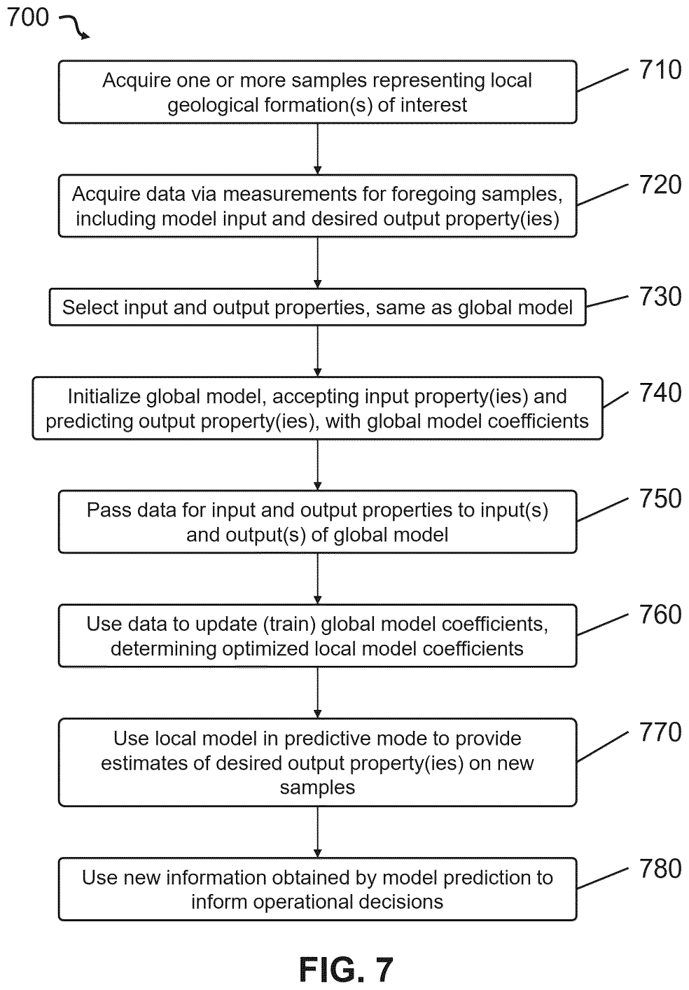

FIG. 7 is a flowchart for an example workflow.

Example embodiments for locally optimizing the prediction of a formation property or properties may enable operational decisions or actions to be performed utilizing the new information gained about the formation property or properties. In FIG. 7, an example workflow 700 may include a first operation 710 of obtaining samples of one or more subsurface geological rock formations of interest, such as a target rock strata for the production or injection of fluids from or into the strata. Samples may be obtained as physical pieces of the rock formation, such as drill cuttings or drill core, returned to the surface in the act of drilling a borehole or borehole sidewall. As another example, samples could be rock surrounding the borehole or set of boreholes. In a next operation 720, measurements and data may be acquired on the samples. The data may be obtained by making measurements at the surface on representative physical pieces of rock or by making measurements directly within a borehole using wellbore logging sondes traversing the borehole. The data may include local data representing at least the set of input (e.g., formation features) and output (e.g., formation target) properties used in a petrophysical model. A next operation 730 may be to select from the locally acquired data the set of model inputs and outputs for a model, the set of inputs and outputs being the same as those used by a pre-trained global model for making predictions as to the output property value or values from the input property value or values. A next operation 740 may be to initialize or load, such as from a data storage and retrieval system, the pre-trained global model, the global model accepting a set of input properties and output a set of output property or properties as selected in operation 730, and the model including a group of pre-trained model coefficients (e.g., neuron weights, etc.). A next operation 750 may be to pass the local dataset of input property(ies) and target output property(ies), the data being derived in operation 720, to the global model input(s) and output(s). Then, in operation 760, the local data may be used to train and optimize a set or subset of the coefficient values (e.g., neuron parameters such as neuron weights, within an artificial neural network) of the pre-trained global model, thus obtaining an optimized local model for the geological rock formation(s) of interest. Subsequently, the foregoing local model can be used in a predictive mode to provide a more accurate characterization of formation properties in local geological formation(s) of interest as an output from the local model. In operation 770, the local model employed in a predictive mode may accept a set of model input property(ies), as selected in operation 730, the data representing the model inputs being acquired by measurements of new samples representing a geological formation(s) of interest. The new samples for the data may be obtained from measurements within or at the surface of the first borehole or from drilling a second or more boreholes into the geological rock formation and by making measurements within the borehole, e.g., using wellbore logging sondes traversing the borehole or by making measurements at the surface on representative samples, such as drill cuttings or drill core returned to the surface in the act of drilling the borehole or borehole sidewalls. This system may provide, for example, a field-scale, reservoir-scale, or similar, characterization of the desired properties of the geological rock formation(s). From the model predictions and output of new information pertaining to desired properties of the geological rock formation(s), actions of operation 780 may be taken based on the new information obtained from the above operations.

As an example of an application of an action in operation 780, in respect of the aforementioned mineralogical example, a locally optimized mineralogical model may be compared to target lithofacies to determine in-zone criteria. The mineralogical model optimized on data acquired from measurements taken in one or more boreholes may then be applied in the same boreholes, in other existing boreholes, or in new boreholes to be drilled near the same local area. Predictions from the locally optimized model may be used to make operational decisions, such as to select specific zones for oil or gas production. For example, those specific zones may be installed with certain hardware or may be perforated to enable the flow of hydrocarbon fluids. As another example of an action for operation 780, a locally optimized petrophysical correlation and model may be used to select specific zones for carbon dioxide (CO₂) injection, and to choose a rate at which CO₂ will be injected to achieve good operation performance. As another example of an application of an action for step 780, a locally optimized model may provide geosteering operational insight about whether a borehole trajectory falls or lands within a target zone, such as a reservoir production target for oil and gas recovery or injection target for CO₂ sequestration, or is missing or missed the target zone and requires change in drill trajectory. As another example of an action for operation 780, locally optimized petrophysical correlation and model such as the quantification of trace, substitutive chemical elements in a rock formation (e.g., boron (B), lithium (Li)) from the measurement of major, structural rock-forming elements in the same rock formation (e.g., Si, Al, Ca, Mg, Fe, etc.), for which no global correlation exists, may be beneficial for the identification of geochemical anomalies. For example, high-boron formation intervals may contribute to anomalous neutron capture (Sigma) responses and Sigma-based fluid saturations that can yield erroneous estimates of water-cut in oil and gas production operations. Thus, a process to locally optimize the determination of boron may have benefit and action in optimizing a petrophysical evaluation. Similarly, the characterization of high-lithium bearing rock intervals may have a benefit in determining zones from which to extract lithium from the rock or fluids surrounding the rock. As another example of an application of an action for step 780, a locally optimized petrophysical correlation and model, such as an estimate of the cation-exchange capacity of the rock from borehole resistivity, dielectric, spectroscopy, and the like, can be used to identify problematic swelling clay minerals in the rock formation that require action, such as adjusting drilling mud composition or mud weight to prevent drilling problems, such as borehole instability.

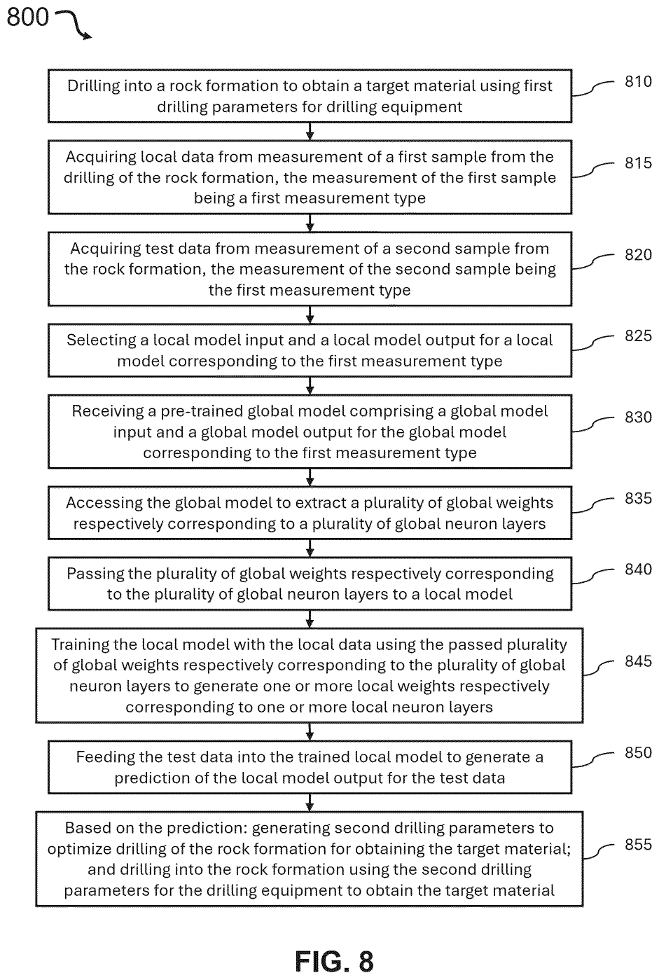

FIG. 8 is a flowchart for an example method.

With reference to FIG. 8, an example method 800 may include, at 810, drilling into a rock formation to obtain a target material using first drilling parameters for drilling equipment. The example method 800 may further include, at 815, acquiring local data from measurement of a first sample from the drilling of the rock formation, the measurement of the first sample being a first measurement type. The example method 800 may further include, at 820, acquiring test data from measurement of a second sample from the rock formation, the measurement of the second sample being the first measurement type. The example method 800 may further include, at 825, selecting a local model input and a local model output for a local model corresponding to the first measurement type. The example method 800 may further include, at 830, receiving a pre-trained global model comprising a global model input and a global model output for the global model corresponding to the first measurement type. The example method 800 may further include, at 835, accessing the global model to extract a plurality of global weights respectively corresponding to a plurality of global neuron layers. The example method 800 may further include, at 840, passing the plurality of global weights respectively corresponding to the plurality of global neuron layers to a local model. The example method 800 may further include, at The example method 800 may further include, at 845, training the local model with the local data using the passed plurality of global weights respectively corresponding to the plurality of global neuron layers to generate one or more local weights respectively corresponding to one or more local neuron layers. The example method 800 may further include, at 850, feeding the test data into the trained local model to generate a prediction of the local model output for the test data. The example method 800 may further include, at 855, based on the prediction: generating second drilling parameters to optimize drilling of the rock formation for obtaining the target material; and drilling into the rock formation using the second drilling parameters for the drilling equipment to obtain the target material.

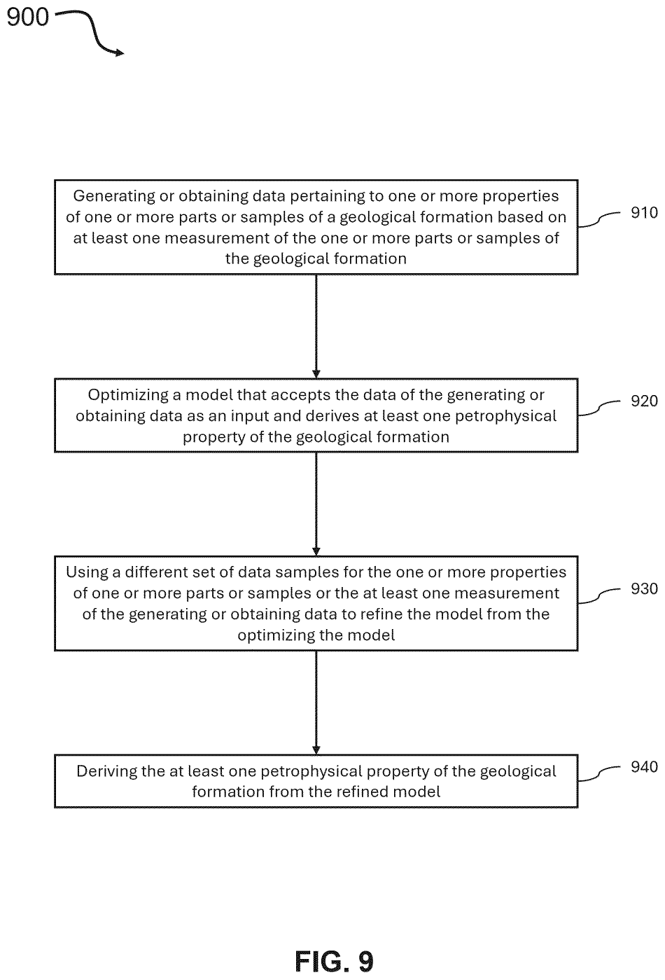

FIG. 9 is a flowchart for an example method.

With reference to FIG. 9, an example method 900 may include, at 910, generating or obtaining data pertaining to one or more properties of one or more parts or samples of a geological formation based on at least one measurement of the one or more parts or samples of the geological formation. The example method 900 may further include, at 920, optimizing a model that accepts the data of the generating or obtaining data as an input and derives at least one petrophysical property of the geological formation. The example method 900 may further include, at 930, using a different set of data samples for the one or more properties of one or more parts or samples or the at least one measurement of the generating or obtaining data to refine the model from the optimizing the model. The example method 900 may further include, at 940, deriving the at least one petrophysical property of the geological formation from the refined model.

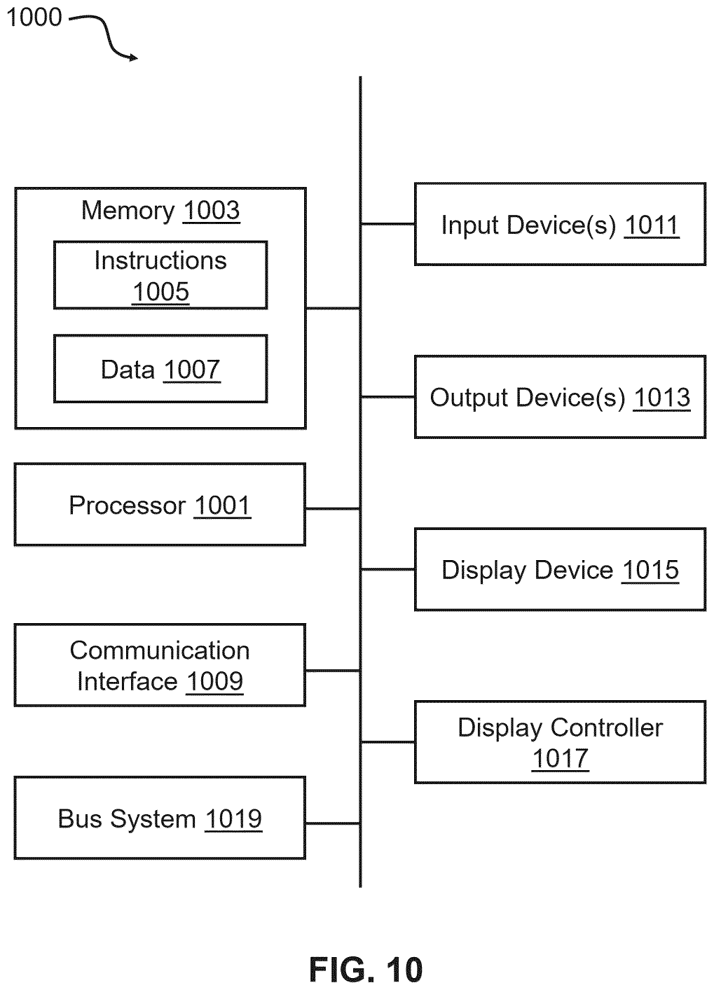

FIG. 10 illustrates certain components that may be included within a computer system according to an example embodiment of the present disclosure.

FIG. 10 illustrates certain components that may be included within a computer system 1000, which may be used to control features according to embodiments of the present disclosure, such as the features discussed with reference to FIGS. 1-9. One or more computer systems 1000 may be used to implement the various devices, components, and systems described herein.

The computer system 1000 includes one or more processors 1001. The processor(s) 1001 may be a single processor or may include multiple processors and/or sub-processors. The processor(s) 1001 may be a general-purpose single- or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor(s) 1001 may be referred to as a central processing unit (CPU). Although a single processor(s) 1001 is shown in the computer system 1000 of FIG. 10, in an alternative configuration, a combination of processors (e.g., an ARM and DSP) could be used. In one or more embodiments, the computer system 1000 further includes one or more graphics processing units (GPUs), which can provide processing services related to both entity classification and graph generation.

The computer system 1000 also includes memory 1003 in electronic communication with the processor(s) 1001. The memory 1003 may be any electronic component capable of storing electronic information. For example, the memory 1003 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, at least one non-transitory computer-readable and/or processor-readable medium, and so forth, including combinations thereof. The memory may include a single memory device or multiple memory devices.

Instructions 1005 and data 1007 may be stored in the memory 1003. The instructions 1005 may be executable by the processor(s) 1001 to implement some or all of the functionality disclosed herein. Executing the instructions 1005 may involve the use of the data 1007 that is stored in the memory 1003. Any of the various examples of modules and components described herein may be implemented, partially or wholly, as instructions 1005 stored in memory 1003 and executed by the processor(s) 1001. Any of the various examples of data described herein may be among the data 1007 that is stored in memory 1003 and used during execution of the instructions 1005 by the processor(s) 1001.

A computer system 1000 may also include one or more communication interfaces 1009 for communicating with other electronic devices. The communication interface(s) 1009 may be based on wired communication technology, wireless communication technology, or both. Some examples of communication interfaces 1009 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 1000 may also include one or more input devices 1011 and one or more output devices 1013. Some examples of input devices 1011 include a keyboard, mouse, microphone, remote control device, button, joystick, trackball, touchpad, and lightpen. Some examples of output devices 1013 include a speaker and a printer. One specific type of output device that is typically included in a computer system 1000 is a display device 1015. Display devices 1015 used with embodiments disclosed herein may utilize any suitable image projection technology, such as liquid crystal display (LCD), light-emitting diode (LED), gas plasma, electroluminescence, or the like. A display controller 1017 may also be provided, for converting data 1007 stored in the memory 1003 into text, graphics, and/or moving images (as appropriate) shown on the display device 1015.

The various components of the computer system 1000 may be coupled together by one or more buses, which may include a power bus, a control signal bus, a status signal bus, a data bus, etc. For the sake of clarity, the various buses are illustrated in FIG. 10 as a bus system 1019.

The following are sections in accordance with at least one embodiment of the present disclosure:

Clause 1: A method, including: drilling into a rock formation to obtain a target material using first drilling parameters for drilling equipment, acquiring local data from measurement of a first sample from the drilling of the rock formation, the measurement of the first sample being a first measurement type, acquiring test data from measurement of a second sample from the rock formation, the measurement of the second sample being the first measurement type, selecting a local model input and a local model output for a local model corresponding to the first measurement type, receiving a pre-trained global model including a global model input and a global model output for the global model corresponding to the first measurement type, accessing the global model to extract a plurality of global weights respectively corresponding to a plurality of global neuron layers, passing the plurality of global weights respectively corresponding to the plurality of global neuron layers to a local model, training the local model with the local data using the passed plurality of global weights respectively corresponding to the plurality of global neuron layers to generate one or more local weights respectively corresponding to one or more local neuron layers, feeding the test data into the trained local model to generate a prediction of the local model output for the test data, and based on the prediction: generating second drilling parameters to optimize drilling of the rock formation for obtaining the target material, and drilling into the rock formation using the second drilling parameters for the drilling equipment to obtain the target material.

Clause 2: The method of clause 1, wherein the one or more local weights respectively corresponding to one or more local neuron layers are generated by adjusting one or more of the passed plurality of global weights while at least one of the passed plurality of global weights is unchanged.

Clause 3: The method of clause 2, wherein the unchanged at least one of the passed plurality of global weights is included in at least one unchanged global layer passed to the local model.

Clause 4: The method of clause 1, wherein the one or more local weights respectively corresponding to one or more local neuron layers are generated by generating at least one new local layer with new local weights while all of the passed plurality of global weights are unchanged.

Clause 5: The method of clause 4, wherein the unchanged passed plurality of global weights are included in unchanged global layers passed to the local model.

Clause 6: A method, including: generating or obtaining data pertaining to one or more properties of one or more parts or samples of a geological formation based on at least one measurement of the one or more parts or samples of the geological formation, optimizing a model that accepts the data of the generating or obtaining data as an input and derives at least one petrophysical property of the geological formation, using a different set of data samples for the one or more properties of one or more parts or samples or the at least one measurement of the generating or obtaining data to refine the model from the optimizing the model, and deriving the at least one petrophysical property of the geological formation from the refined model.

Clause 7: The method of clause 6, wherein the one or more parts or samples of the geological formation includes one or more of: a rock chip, a rock core, a rock drill cutting, a rock outcrop, or a rock formation surrounding a borehole.

Clause 8: The method of clause 6, wherein the at least one measurement is performed on one or more of: the one or more parts or samples of the geological formation conveyed to a surface of the geological formation, or the one or more parts or samples located within a borehole penetrating the geological formation.

Clause 9: The method of clause 6, wherein the at least one measurement includes one or more of: a gamma ray measurement, a neutron-induced gamma ray spectroscopy measurement, a gamma ray-induced gamma ray spectroscopy measurement, an acoustic log measurement, a nuclear magnetic resonance measurement, bulk density, thermal neutron porosity, epithermal neutron porosity, a pulsed-neutron measurement, a resistivity measurement, a conductivity measurement, an elemental concentration, a sonic property, an ultrasonic property, a dielectric property, a borehole image, seismic data, a fiber optic measurement, a gravity measurement, or a combination thereof.

Clause 10: The method of clause 6, wherein the at least one petrophysical property includes one or more of: rock grain density, rock apparent thermal neutron porosity, rock apparent epithermal neutron porosity, rock total porosity, rock effective porosity, rock hydrogen index, rock permittivity, rock thermal-neutron absorption cross-section, matrix fast-neutron elastic cross-section, rock photoelectric factor, rock permeability, cation-exchange capacity of the rock, a rock mineral concentration, a rock atomic elemental concentration, rock heat capacity, rock enthalpy, rock thermal conductivity, a rock reactivity rate with respect to an acid, a rock reactivity rate with respect to carbon dioxide, a rock propensity to produce geological hydrogen, elastic moduli, a mechanical property, or a combination thereof.

Clause 11: The method of clause 6, wherein the model includes one or more neural networks.

Clause 12: The method of clause 11, wherein at least one of the one or more neural networks includes at least one of: an artificial neural network (ANN), a Bayesian neural network (BNN), a convolution neural network, or a combination thereof.

Clause 13: The method of clause 6, wherein: the model is trained on a set of data from a global variety of geological formations, and the different set of data samples used to refine the model is based on a local subset of geological formations.

Clause 14: The method of clause 6, wherein: the model is trained on a global dataset of samples, and the different set of data samples used to refine the model includes a smaller number of samples than the global dataset.

Clause 15: The method of clause 6, wherein the refining the model based on the different set of data samples is based on at least one confidence assessment process applied to the model in a context of new data.

Clause 16: The method of clause 6, wherein: the model includes a plurality of model coefficients, and the refining the model includes updating a subset of the coefficients whose values were learned in training the model.

Clause 17: The method of clause 6, wherein: the model includes a plurality of model coefficients, and the refining the model includes incorporating a new set of coefficients into the model whose values are learned during the refining the model.

Clause 18: A system, including: one or more processors, memory accessible to the one or more processors, and processor-executable instructions stored in the memory and executable by the one or more processors to instruct the system to: drill into a rock formation to obtain a target material using first drilling parameters for drilling equipment, acquire local data from measurement of a first sample from the drilling of the rock formation, the measurement of the first sample being a first measurement type, acquire test data from measurement of a second sample from the rock formation, the measurement of the second sample being the first measurement type, select a local model input and a local model output for a local model corresponding to the first measurement type, receive a pre-trained global model including a global model input and a global model output for the global model corresponding to the first measurement type, access the global model to extract a plurality of global weights respectively corresponding to a plurality of global neuron layers, pass the plurality of global weights respectively corresponding to the plurality of global neuron layers to a local model, train the local model with the local data using the passed plurality of global weights respectively corresponding to the plurality of global neuron layers to generate one or more local weights respectively corresponding to one or more local neuron layers, feed the test data into the trained local model to generate a prediction of the local model output for the test data, and based on the prediction: generate second drilling parameters to optimize drilling of the rock formation for obtaining the target material, and drill into the rock formation using the second drilling parameters for the drilling equipment to obtain the target material.

Clause 19: The system of clause 18, wherein the one or more local weights respectively corresponding to one or more local neuron layers are generated by adjusting one or more of the passed plurality of global weights while at least one of the passed plurality of global weights is unchanged.

Clause 20: The system of clause 19, wherein the unchanged at least one of the passed plurality of global weights is included in at least one unchanged global layer passed to the local model.

Clause 21: The system of clause 18, wherein the one or more local weights respectively corresponding to one or more local neuron layers are generated by generating at least one new local layer with new local weights while all of the passed plurality of global weights are unchanged.

Clause 22: The system of clause 21, wherein the unchanged passed plurality of global weights are included in unchanged global layers passed to the local model.

Systems and software, e.g., implemented on a non-transitory computer-readable medium, for performing the methods discussed herein are also within the scope of embodiments of the present disclosure.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims. Any trademarks mentioned herein are the property of their respective owners. Example embodiments are not limited to any particularly-mentioned products, trademarks, or properties.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
drilling into a rock formation to obtain a target material using first drilling parameters for drilling equipment;
acquiring local data from measurement of a first sample from the drilling of the rock formation, the measurement of the first sample being a first measurement type;
acquiring test data from measurement of a second sample from the rock formation, the measurement of the second sample being the first measurement type;
selecting a local model input and a local model output for a local model corresponding to the first measurement type;
receiving a pre-trained global model comprising a global model input and a global model output for the global model corresponding to the first measurement type;
accessing the global model to extract a plurality of global weights respectively corresponding to a plurality of global neuron layers;
passing the plurality of global weights respectively corresponding to the plurality of global neuron layers to a local model;
training the local model with the local data using the passed plurality of global weights respectively corresponding to the plurality of global neuron layers to generate one or more local weights respectively corresponding to one or more local neuron layers;
feeding the test data into the trained local model to generate a prediction of the local model output for the test data; and
based on the prediction:
generating second drilling parameters to optimize drilling of the rock formation for obtaining the target material; and
drilling into the rock formation using the second drilling parameters for the drilling equipment to obtain the target material.

2. The method of claim 1, wherein the one or more local weights respectively corresponding to one or more local neuron layers are generated by adjusting one or more of the passed plurality of global weights while at least one of the passed plurality of global weights is unchanged.

3. The method of claim 2, wherein the unchanged at least one of the passed plurality of global weights is included in at least one unchanged global layer passed to the local model.

4. The method of claim 1, wherein the one or more local weights respectively corresponding to one or more local neuron layers are generated by generating at least one new local layer with new local weights while all of the passed plurality of global weights are unchanged.

5. The method of claim 4, wherein the unchanged passed plurality of global weights are included in unchanged global layers passed to the local model.

6. A method, comprising:
generating or obtaining data pertaining to one or more properties of one or more parts or samples of a geological formation based on at least one measurement of the one or more parts or samples of the geological formation;
optimizing a model that accepts the data of the generating or obtaining data as an input and derives at least one petrophysical property of the geological formation;
using a different set of data samples for the one or more properties of one or more parts or samples or the at least one measurement of the generating or obtaining data to refine the model from the optimizing the model; and
deriving the at least one petrophysical property of the geological formation from the refined model.

7. The method of claim 6, wherein the one or more parts or samples of the geological formation comprises one or more of: a rock chip, a rock core, a rock drill cutting, a rock outcrop, or a rock formation surrounding a borehole.

8. The method of claim 6, wherein the at least one measurement is performed on one or more of:
the one or more parts or samples of the geological formation conveyed to a surface of the geological formation; or
the one or more parts or samples located within a borehole penetrating the geological formation.

9. The method of claim 6, wherein the at least one measurement comprises one or more of: a gamma ray measurement, a neutron-induced gamma ray spectroscopy measurement, a gamma ray-induced gamma ray spectroscopy measurement, an acoustic log measurement, a nuclear magnetic resonance measurement, bulk density, thermal neutron porosity, epithermal neutron porosity, a pulsed-neutron measurement, a resistivity measurement, a conductivity measurement, an elemental concentration, a sonic property, an ultrasonic property, a dielectric property, a borehole image, seismic data, a fiber optic measurement, a gravity measurement, or a combination thereof.

10. The method of claim 6, wherein the at least one petrophysical property comprises one or more of: rock grain density, rock apparent thermal neutron porosity, rock apparent epithermal neutron porosity, rock total porosity, rock effective porosity, rock hydrogen index, rock permittivity, rock thermal-neutron absorption cross-section, matrix fast-neutron elastic cross-section, rock photoelectric factor, rock permeability, cation-exchange capacity of the rock, a rock mineral concentration, a rock atomic elemental concentration, rock heat capacity, rock enthalpy, rock thermal conductivity, a rock reactivity rate with respect to an acid, a rock reactivity rate with respect to carbon dioxide, a rock propensity to produce geological hydrogen, elastic moduli, a mechanical property, or a combination thereof.

11. The method of claim 6, wherein the model comprises one or more neural networks.

12. The method of claim 11, wherein at least one of the one or more neural networks comprises at least one of: an artificial neural network (ANN), a Bayesian neural network (BNN), a convolution neural network, or a combination thereof.

13. The method of claim 6, wherein:
the model is trained on a set of data from a global variety of geological formations; and
the different set of data samples used to refine the model is based on a local subset of geological formations.

14. The method of claim 6, wherein:
the model is trained on a global dataset of samples; and
the different set of data samples used to refine the model comprises a smaller number of samples than the global dataset.

15. The method of claim 6, wherein the refining the model based on the different set of data samples is based on at least one confidence assessment process applied to the model in a context of new data.

16. The method of claim 6, wherein:
the model comprises a plurality of model coefficients; and
the refining the model includes updating a subset of the coefficients whose values were learned in training the model.

17. The method of claim 6, wherein:
the model comprises a plurality of model coefficients; and
the refining the model includes incorporating a new set of coefficients into the model whose values are learned during the refining the model.

18. A system, comprising:
one or more processors;
memory accessible to the one or more processors; and
processor-executable instructions stored in the memory and executable by the one or more processors to instruct the system to:
drill into a rock formation to obtain a target material using first drilling parameters for drilling equipment;
acquire local data from measurement of a first sample from the drilling of the rock formation, the measurement of the first sample being a first measurement type;
acquire test data from measurement of a second sample from the rock formation, the measurement of the second sample being the first measurement type;
select a local model input and a local model output for a local model corresponding to the first measurement type;
receive a pre-trained global model comprising a global model input and a global model output for the global model corresponding to the first measurement type;
access the global model to extract a plurality of global weights respectively corresponding to a plurality of global neuron layers;
pass the plurality of global weights respectively corresponding to the plurality of global neuron layers to a local model;
train the local model with the local data using the passed plurality of global weights respectively corresponding to the plurality of global neuron layers to generate one or more local weights respectively corresponding to one or more local neuron layers;
feed the test data into the trained local model to generate a prediction of the local model output for the test data; and
based on the prediction:
generate second drilling parameters to optimize drilling of the rock formation for obtaining the target material; and
drill into the rock formation using the second drilling parameters for the drilling equipment to obtain the target material.

19. The system of claim 18, wherein the one or more local weights respectively corresponding to one or more local neuron layers are generated by adjusting one or more of the passed plurality of global weights while at least one of the passed plurality of global weights is unchanged.

20. The system of claim 19, wherein the unchanged at least one of the passed plurality of global weights is included in at least one unchanged global layer passed to the local model.

21. The system of claim 18, wherein the one or more local weights respectively corresponding to one or more local neuron layers are generated by generating at least one new local layer with new local weights while all of the passed plurality of global weights are unchanged.

22. The system of claim 21, wherein the unchanged passed plurality of global weights are included in unchanged global layers passed to the local model.
